(19) United States
(12) Patent Application Publication
(10) Pub. No.: US 2023/0250782 A1
(43) Pub. Date: Aug. 10, 2023

(54) AIR CLEANER DEGRADATION DEGREE ESTIMATION DEVICE AND AIR CLEANER DEGRADATION DEGREE ESTIMATION METHOD

(71) Applicant: TOYOTA JIDOSHA KABUSHIKI KAISHA, Aichi-ken (JP)

(72) Inventor: Shunsuke RIKITAKE, Toyota-shi (JP)

(21) Appl. No.: 18/165,331

(22) Filed: Feb. 7, 2023

(30) Foreign Application Priority Data
Feb. 9, 2022 (JP) 2022-018996

(51) Int. Cl. F02M 35/09; B01D 46/00

(52) U.S. Cl. CPC F02M 35/09; B01D 46/0086

(57) ABSTRACT

An air cleaner degradation degree estimation device, includes: a processor configured to: acquire location information indicating a location of a vehicle; acquire information relating to an air pollution index in an area corresponding to the location information; calculate an air cleaner degradation degree based on a travel distance of the vehicle; and correct the air cleaner degradation degree based on the air pollution index.

### CROSS-REFERENCE TO RELATED APPLICATION

This application is based on and claims priority under 35 USC 119 from Japanese Patent Application No. 2022-018996 filed on Feb. 9, 2022, the disclosure of which is incorporated by reference herein.

### BACKGROUND

### Technical Field

The present disclosure relates to an air cleaner degradation degree estimation device and an air cleaner degradation degree estimation method.

### Related Art

Japanese Patent Application Laid-Open (JP-A) No. 2018-100653 discloses a pollution degree estimation device that acquires travel condition information for each travel section, and estimates the degree of pollution in an air cleaner based on the travel condition information.

However, since the pollution degree estimation device of JP-A No. 2018-100653 does not consider the condition of air pollution in the travel area of the vehicle, there is room for improvement in order to accurately estimate the degree of degradation of the air cleaner.

### SUMMARY

The present disclosure provides an air cleaner degradation degree estimation device and an air cleaner degradation degree estimation method capable of accurately estimating the degree of degradation of the air cleaner.

An air cleaner degradation degree estimation device according to a first aspect includes a processor configured to: acquire location information indicating a location of a vehicle; acquire information relating to an air pollution index in an area corresponding to the location information; calculate an air cleaner degradation degree based on a travel distance of the vehicle; and correct the air cleaner degradation degree based on the air pollution index.

In the air cleaner degradation degree estimation device according to the first aspect, the processor acquires location information of the vehicle. Moreover, the processor acquires information relating to the air pollution index in the area corresponding to the location information. The processor then calculates the degree of degradation of the air cleaner based on the travel distance of the vehicle, and corrects the degree of degradation of the air cleaner based on the air pollution index. This enables the degree of degradation of the air cleaner to be estimated in consideration of air pollution in the travel area of the vehicle, in comparison to cases in which the degree of degradation of the air cleaner is calculated based only on the travel distance of the vehicle.

In a second aspect of the present disclosure, in the first aspect, the processor may be configured to acquire the air pollution index corresponding to a concentration of PM2.5.

In the air cleaner degradation degree estimation device according to the second aspect, since the processor acquires the air pollution index corresponding to the concentration of PM2.5, it is estimated that the degradation of the air cleaner is progressing as the concentration of PM2.5 becomes higher. Since degradation of the air cleaner is mainly caused by clogging of the filter, the degree of degradation of the air cleaner can be accurately estimated by correcting the degree of degradation of the air cleaner based on a substance that greatly contributes to clogging of the filter, such as PM2.5.

In a third aspect of the present disclosure, in the first aspect or the second aspect, the processor may be configured to correct the air cleaner degradation degree based on an average value that is calculated by acquiring the information relating to the air pollution index multiple times during a day.

In the air cleaner degradation degree estimation device according to the third aspect, processor acquires information relating to the air pollution index multiple times during a day and calculates an average value, thereby enabling the degree of degradation of the air cleaner to be corrected in consideration of variations in the air pollution index during the day. For example, the air pollution index may fluctuate in an area in which there is a factory, depending on the operating time of the factory. Moreover, since an air pollution index tends to fluctuate during times when the movement of people is large, such as during commuting hours and at the time of leaving work, calculating the time average of the air pollution index enables the degree of degradation of the air cleaner to be accurately estimated in comparison to cases in which the air pollution index is acquired only once a day.

An air cleaner degradation degree estimation method according to a fourth aspect includes: acquiring location information indicating a location of a vehicle; acquiring information relating to an air pollution index in an area corresponding to the location information; calculating an air cleaner degradation degree based on a travel distance of the vehicle; and correcting the air cleaner degradation degree based on the air pollution index.

The air cleaner degradation degree estimation device and the air cleaner degradation degree estimation method according to the present disclosure can accurately estimate the degree of degradation of an air cleaner.

### BRIEF DESCRIPTION OF THE DRAWINGS

An exemplary embodiment of the present disclosure will be described in detail based on the following figures, wherein:

FIG. 1 is a block diagram illustrating a hardware configuration of an air cleaner degradation degree estimation device according to an exemplary embodiment.

FIG. 2 is a block diagram illustrating a functional configuration of an air cleaner degradation degree estimation device according to an exemplary embodiment.

FIG. 3 is a flowchart illustrating an example of a flow of air cleaner degradation degree estimation processing according to an exemplary embodiment.

### DETAILED DESCRIPTION

Explanation follows regarding an air cleaner degradation degree estimation device 10 according to an exemplary embodiment, with reference to the drawings.

The degradation degree estimation device 10 of the present exemplary embodiment is installed at a vehicle and is a device that estimates a degree of degradation of an air cleaner. Moreover, a time for replacement of the air cleaner is notified to a user at a timing when a time to replace the air cleaner is approaching. Note that the user may acquire information relating to the scheduled time to replace the air cleaner at an arbitrary timing.

Hardware Configuration of Degradation Degree Estimation Device 10

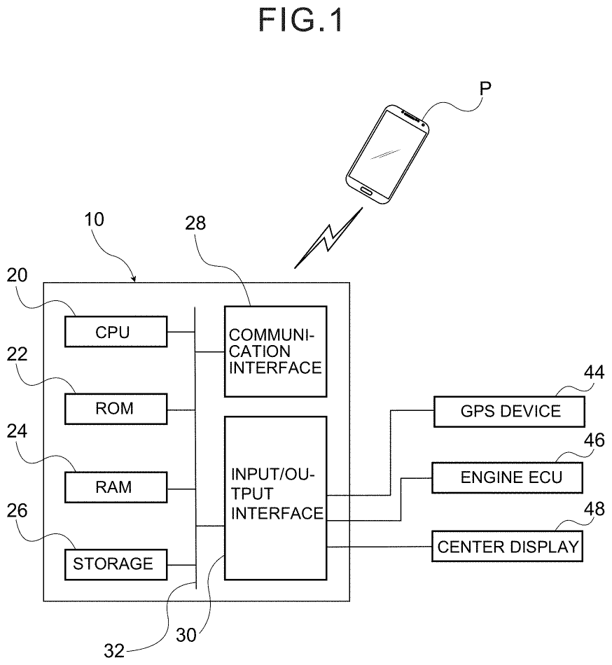

FIG. 1 is a block diagram illustrating a hardware configuration of the degradation degree estimation device 10. As illustrated in FIG. 1, the degradation degree estimation device 10 includes a central processing unit (CPU; a processor) 20, read only memory (ROM) 22, random access memory (RAM) 24, storage 26, a communication interface 28, and an input/output interface 30. These respective configurations are connected together via a bus 32 so as to be capable of communicating with each other.

The CPU 20 is a central processing unit that executes various programs and controls various components. Namely, the CPU 20 reads a program from the ROM 22 or the storage 26, and executes the program using the RAM 24 as a workspace. The CPU 20 controls the respective configurations and performs various computation processing in accordance with a program recorded in the ROM 22 or the storage 26.

The ROM 22 stores various programs and various data. The RAM 24 serves as a workspace to temporarily store programs and data. The storage 26 is configured by a hard disk drive (HDD) or a solid state drive (SSD), and stores various programs including an operating system, as well as various data. In the present exemplary embodiment, a program, various data, and the like for performing various processing are stored in the ROM 22 or the storage 26.

The communication interface 28 is an interface for the degradation degree estimation device 10 to communicate with non-illustrated equipment such as a server and, for example, a protocol such as Controller Area Network (CAN), Ethernet (registered trademark), Long Term Evolution (LTE), Fiber Distributed Data Interface (FDDI), or Wi-Fi (registered trademark) is used. Moreover, the communication interface 28 is configured to be capable of communicating with a mobile terminal P that is carried by a driver.

A Global Positioning System (GPS) device 44, an engine ECU 46, and a center display 48 are electrically connected to the input/output interface 30.

The GPS device 44 receives GPS signals from plural GPS satellites to measure the location of the host vehicle.

The engine ECU 46 is a control device for controlling the engine of the vehicle, and holds information such as the total number of revolutions of the engine, the load usage rate of the engine, and the like. Further, the engine ECU 46 also holds information relating to the usage rate of an exhaust gas recirculation (EGR) device. The degradation degree estimation device 10 is configured so as to be able to acquire information on the usage rate of the exhaust gas recirculation device from the engine ECU 46 via the input/output interface 30.

The center display 48 is provided at a position at the front of the vehicle cabin that is visible to the driver, and displays various information. For example, the center display 48 displays information relating to a time to replace the air cleaner.

Functional Configuration of Degradation Degree Estimation Device 10

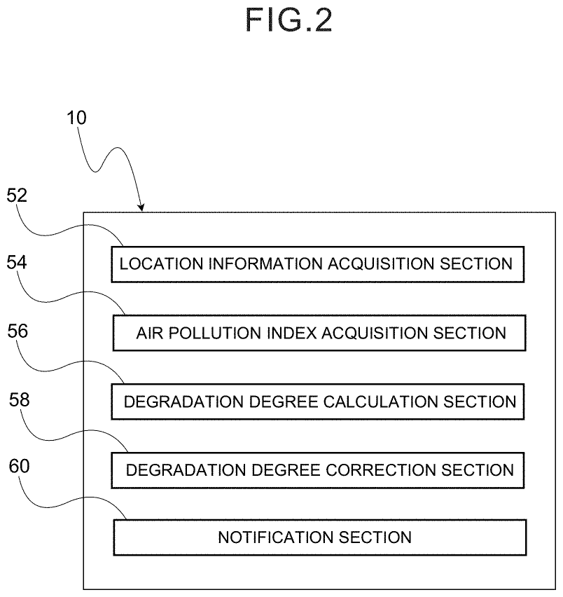

The degradation degree estimation device 10 implements various functions using the above-described hardware resources. Explanation follows regarding the functional configuration implemented by the degradation degree estimation device 10, with reference to FIG. 2.

As illustrated in FIG. 2, the degradation degree estimation device 10 includes, as a functional configuration, a location information acquisition section 52, an air pollution index acquisition section 54, a degradation degree calculation section 56, a degradation degree correction section 58, and a notification section 60. The respective functional configurations are implemented by the CPU 20 reading and executing a program stored in the ROM 22 or the storage 26.

The location information acquisition section 52 acquires location information of the vehicle. More specifically, the location information acquisition section 52 acquires location information of the vehicle, for which the location has been measured, based on the GPS signals received by the GPS device 44.

The air pollution index acquisition section 54 acquires information relating to an air pollution index in an area corresponding to the location information of the vehicle. More specifically, the air pollution index acquisition section 54 acquires the air pollution index of the area, including the location of the vehicle acquired by the location information acquisition section 52.

In the present exemplary embodiment, as an example, the air pollution index acquisition section 54 acquires an air pollution index from a website that discloses an index of the concentration of air pollutants observed in major cities based on the Air Quality Index (AQI) established by the United States Environmental Protection Agency.

Cases in which the index is 0 to 50 are classified as “Good” with little health effects, while cases in which the index is 51 to 100 are classified as “Moderate” with moderate health effects. Further, in cases in which the index is 101 to 150, health effects are classified as “Unhealthy for Sensitive Groups”, meaning adverse health effects for sensitive groups, and in cases in which the index is 151 to 200, health effects are classified as “Unhealthy”, meaning adverse health effects. Moreover, cases in which the index is 201 to 300 are classified as “Very Unhealthy”, meaning very adverse health effects, while cases in which the index is 301 to 500 are classified as “Hazardous”, meaning dangerous health effects.

As an example, in the present exemplary embodiment, the air pollution index acquisition section 54 is configured to acquire the air pollution index corresponding to the concentration of PM2.5 among air pollutants several times during a day. Note that in a case in which the average air pollution index per day is disclosed, the air pollution index acquisition section 54 may acquire the average air pollution index.

The degradation degree calculation section 56 calculates the degradation degree of the air cleaner based on a travel distance of the vehicle. More specifically, data indicating a relationship between a travel distance of the vehicle and a cumulative air flow is stored in advance on a predetermined external server, and the degradation degree calculation section 56 calculates a cumulative air flow corresponding to the travel distance of the vehicle from the relationship between the travel distance and the cumulative air flow stored in the external server.

Data indicating a relationship between the cumulative air flow and an air flow resistance (pressure loss) of a filter is stored in advance on the external server, and the degradation degree calculation section 56 refers to this data to calculate the air flow resistance of the filter corresponding to the cumulative air flow.

The air flow resistance of the filter is known to be proportional to the square of the average flow velocity within the filter, and the area of the filter is proportional to the amount of dust accumulation. For this reason, in a case in which air having a constant dust content is sucked in, the amount of dust accumulated in the filter can be considered to be proportional to the cumulative value of the air passing through the filter, and since the cumulative air flow and the average flow velocity inside the filter are proportional, the air flow resistance of the filter is proportional to the square of the cumulative air flow. For this reason, data indicating the relationship between the cumulative air flow and the air flow resistance (pressure loss) of the filter is a quadratic curve in which the cumulative air flow is plotted on the horizontal axis and the air flow resistance of the filter is plotted on the vertical axis.

As described above, the degradation degree calculation section 56 does not consider the travel area of the vehicle, and in a case in which the type of air cleaner and the travel distance are the same, the degradation degree calculation section 56 calculates the degradation degree of the air cleaner so as to have the same degree of degradation. However, since the size and type of air cleaners differ depending on the type of vehicle, the degradation degree calculation section 56 calculates the degradation degree of the air cleaner using data corresponding to the air cleaner installed at the vehicle.

The degradation degree correction section 58 corrects the degradation degree of the air cleaner based on the air pollution index. More specifically, the degradation degree correction section 58 corrects the degradation degree of the air cleaner, which is calculated by the degradation degree calculation section 56, based on the data of the air pollution index acquired by the air pollution index acquisition section 54.

In the present exemplary embodiment, as an example, an air pollution index of 50 is used as a reference. Accordingly, in a case in which the air pollution index acquired by the air pollution index acquisition section 54 is greater than 50, or in a case in which the air pollution index acquired by the air pollution index acquisition section 54 is less than 50, the degradation degree correction section 58 corrects the degradation degree of the air cleaner.

For example, in a case in which the air pollution index acquired by the air pollution index acquisition section 54 is greater than 50, the degradation degree correction section 58 calculates the ratio between the acquired air pollution index and 50, and based on a quadratic curve indicating the relationship between the cumulative air flow and the air flow resistance of the filter, and the calculated ratio, corrects so as to increase the degree of degradation of the air cleaner.

Conversely, in a case in which the air pollution index acquired by the air pollution index acquisition section 54 is less than 50, the degradation degree correction section 58 calculates the ratio between the acquired air pollution index and 50, and based on a quadratic curve indicating the relationship between the cumulative air flow and the air flow resistance of the filter, and the calculated ratio, corrects so as to reduce the degree of degradation of the air cleaner.

As an example, in the present exemplary embodiment, the degradation degree correction section 58 corrects the degradation degree of the air cleaner in consideration of the usage rate of the EGR device installed at the vehicle. For example, in a state in which the usage rate of the EGR device is high, since a large amount of exhaust gas is reused, the amount of outside air passing through the air cleaner is reduced. In this case, the degradation degree is corrected so as to reduce the degradation degree of the air cleaner as compared to a state in which the usage rate of the EGR device is low.

The notification section 60 notifies the user by displaying at the mobile terminal P and the center display 48 in a case in which the degradation degree of the air cleaner has approached a predetermined numerical value. The notification performed by the notification section 60 may be intermittent until, for example, replacement of the air cleaner has been carried out. Moreover, the notification section 60 may change the display as the time to replace the air cleaner approaches.

Operation

Next, explanation follows regarding operation of the present exemplary embodiment.

Example of Air Cleaner Degradation Degree Estimation Processing

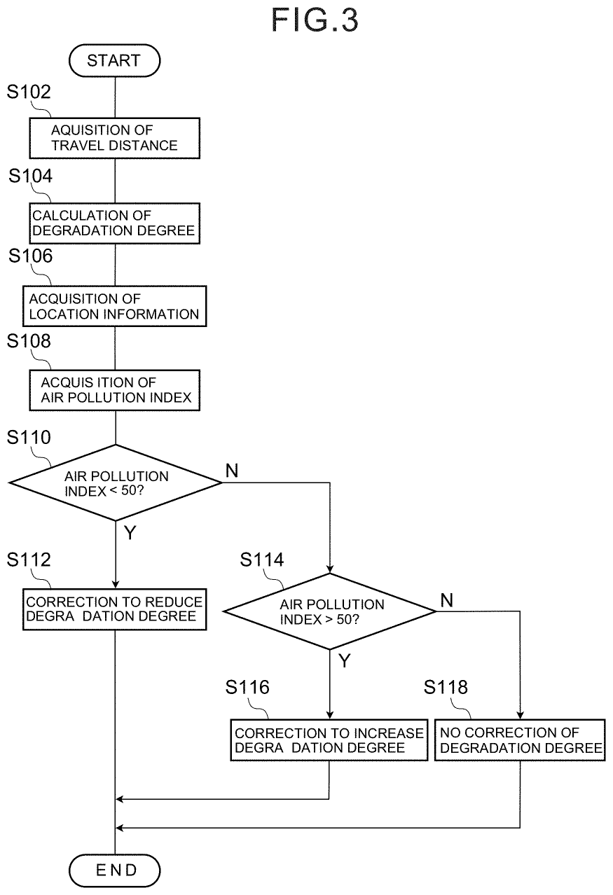

FIG. 3 is a flowchart illustrating an example of a flow of air cleaner degradation degree estimation processing performed by the degradation degree estimation device 10. The degradation degree estimation processing is executed by the CPU 20 reading a program from the ROM 22 or the storage 26 and loading the program in the RAM 24.

As illustrated in FIG. 3, the CPU 20 acquires the travel distance of the vehicle at step S102. The travel distance referred to herein is not the total travel distance of the vehicle, but is the travel distance from when the air cleaner was replaced.

At step S104, the CPU 20 calculates the degree of degradation of the air cleaner. More specifically, the CPU 20 calculates the degradation degree of the air cleaner based on a mathematical formula, which is set in advance, by the functionality of the degradation degree calculation section 56.

At step S106, the CPU 20 acquires location information of the vehicle. More specifically, the CPU 20 acquires location information of the vehicle based on signals from the GPS device 44 installed at the vehicle using the functionality of the location information acquisition section 52.

At step S108, the CPU 20 acquires an air pollution index. More specifically, the CPU 20 acquires the air pollution index using the functionality of the air pollution index acquisition section 54.

At step S110, the CPU 20 determines whether or not the air pollution index is less than 50. In a case in which the air pollution index is less than 50, the CPU 20 transitions to the processing of step S112, while in a case in which the air pollution index is 50 or greater, the CPU 20 transitions to the processing of step S114.

In a case in which the determination at step S110 is affirmative, that is, in a case in which the air pollution index is less than 50, at step S112, the CPU 20 corrects the degree of degradation so as to reduce the degradation degree of the air cleaner. The CPU 20 then ends the degradation degree estimation processing.

On the other hand, in a case in which the determination at step S110 is negative, that is, in a case in which the air pollution index is 50 or greater, at step S114, the CPU 20 determines whether or not the air pollution index is greater than 50. In a case in which the air pollution index is greater than 50, the CPU 20 transitions to the processing of step S116.

At step S116, the CPU 20 corrects the degree of degradation so as to increase the degradation degree of the air cleaner. The CPU 20 then ends the degradation degree estimation processing.

In a case in which the determination at step S114 is negative, that is, in a case in which the air pollution index is equal to 50, at step S118, the CPU 20 ends the degradation degree estimation processing without correcting the degradation degree.

As described above, the degradation degree estimation device 10 of the present exemplary embodiment acquires information relating to the air pollution index in the area corresponding to the location information of the vehicle. Further, the degradation degree of the air cleaner is calculated based on the travel distance of the vehicle, and the degradation degree of the air cleaner is corrected based on the air pollution index. This enables the degradation degree of the air cleaner to be estimated more accurately than in a case in which the degradation degree of the air cleaner is calculated based only on the travel distance of the vehicle. As a result, it is possible for the air cleaner to be used for the duration of its life, and a usable air cleaner from carelessly discarded is inhibited.

In particular, in the present exemplary embodiment, since the air pollution index corresponding to the concentration of PM2.5 is acquired, it is estimated that the higher the concentration of PM2.5, the more advanced the degradation of the air cleaner. Since degradation of the air cleaner is mainly caused by clogging of the filter, the degradation degree of the air cleaner can be estimated more accurately by correcting the degradation degree of the air cleaner based on a substance that greatly contributes to clogging of the filter, such as PM2.5.

Moreover, in the present exemplary embodiment, by acquiring information relating to the air pollution index plural times a day and calculating an average value, the degradation degree of the air cleaner can be corrected in consideration of variations in the air pollution index during a day.

Although explanation has been given in the foregoing regarding the air cleaner degradation degree estimation device 10 according to the exemplary embodiment, it will be clear that various embodiments may be implemented within a range not departing from the gist of the present disclosure. For example, in the exemplary embodiment described above, although the air pollution index acquisition section 54 acquires an index of the concentration of air pollutants based on the AQI established by the United States Environmental Protection Agency, there is no limitation thereto. If there are other organizations that disclose air pollution indices in major cities worldwide, data may be acquired from these organizations.

Further, although the air pollution index acquisition section 54 acquires the air pollution index corresponding to the concentration of PM2.5 in the above-described exemplary embodiment, there is no limitation thereto. For example, an air pollution index may be acquired which corresponds to the concentration of air pollutants, such as PM10, carbon monoxide, and sulfur dioxide.

Moreover, although the air pollution index acquisition section 54 is configured to acquire the air pollution index several times a day in the above-described exemplary embodiment, there is no limitation thereto. For example, the air pollution index acquisition section 54 may be configured to acquire the air pollution index once every few days or once every few months. Further, the air pollution index acquisition section 54 may acquire the air pollution index when the vehicle moves to a different area, based on the location information of the vehicle. In this case, the communication load required to acquire the air pollution index can be suppressed.

Further, in the exemplary embodiment described above, although the degradation degree correction section 58 calculates the ratio between the acquired air pollution index and 50, and based on a quadratic curve indicating the relationship between the cumulative air flow and the air flow resistance of the filter, and the calculated ratio, corrects the degradation degree of the air cleaner, there is no limitation thereto. That is, other methods may be adopted as long as the acquired air pollution index is corrected so as to increase the degradation degree of the air cleaner in a case in which the acquired air pollution index is greater than the reference value, and the acquired air pollution index is corrected so as to decrease the degradation degree of the air cleaner in a case in which the acquired air pollution index is less than the reference value.

Moreover, the processing executed by the CPU 20 reading and executing a program in the above-described exemplary embodiment may be executed by various types of processor other than the CPU 20. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Further, the respective processing may be executed by any one of these various types of processor, or by a combination of two or more of the same type or different types of processor, and may be executed by plural FPGAs, or by a combination of a CPU and an FPGA, for example. The hardware structure of these various types of processors is, more specifically, an electric circuit combining circuit elements such as semiconductor elements.

Although the various data is stored in the storage 26 in the exemplary embodiment described above, there is no limitation thereto. For example, a non-transitory recording medium such as a compact disc (CD), a digital versatile disc (DVD), or universal serial bus (USB) memory may act as a storage section. In this case, various programs, data, and the like are stored in these recording media.

Moreover, the flow of processing described in the above-described exemplary embodiment is an example, and unnecessary steps may be deleted, new steps may be added, or the processing order may be rearranged within a range not departing from the spirit of the present disclosure.

Further, although explanation has been given regarding a configuration in which the air cleaner degradation degree estimation device 10 is provided in a vehicle in the above-described exemplary embodiment, there is no limitation thereto. For example, the degradation degree estimation device 10 may be provided at a facility such as a service center or a dealer. In this case, the degradation degree estimation device 10 may acquire information from a vehicle, a server, or the like using predetermined communication means.

What is claimed is:

1. An air cleaner degradation degree estimation device, comprising:
a processor configured to:
acquire location information indicating a location of a vehicle;
acquire information relating to an air pollution index in an area corresponding to the location information;
calculate an air cleaner degradation degree based on a travel distance of the vehicle; and
correct the air cleaner degradation degree based on the air pollution index.

2. The air cleaner degradation degree estimation device according to claim 1, wherein the processor is configured to acquire the air pollution index corresponding to a concentration of PM2.5.

3. The air cleaner degradation degree estimation device according to claim 1, wherein the processor is configured to correct the air cleaner degradation degree based on an average value that is calculated by acquiring the information relating to the air pollution index multiple times during a day.

4. An air cleaner degradation degree estimation method, comprising:
acquiring location information indicating a location of a vehicle;
acquiring information relating to an air pollution index in an area corresponding to the location information;
calculating an air cleaner degradation degree based on a travel distance of the vehicle; and
correcting the air cleaner degradation degree based on the air pollution index.
